(19) United States
(12) Patent Application Publication
(10) Pub. No.: US 2009/0155525 A1
(43) Pub. Date: Jun. 18, 2009

(54) Passivation-Free Coating Process For A CSF

(76) Inventor: Yuejin Li, Edison, NJ (US)

Correspondence Address: BASF CATALYSTS LLC, 100 CAMPUS DRIVE, FLORHAM PARK, NJ, 07932, US

(21) Appl. No.: 11/959,048

(22) Filed: Dec. 18, 2007

(51) Int. Cl. B32B 3/12; B05D 7/22

(52) U.S. Cl. 428/116; 427/181

(57) ABSTRACT

An emission treatment system and method for simultaneously remediating the nitrogen oxides (NOx), particulate matter, and gaseous hydrocarbons present in diesel engine exhaust streams. The emission treatment system includes a catalyzed soot filter comprising a wall flow monolith and a catalyst comprising support particles. The wall flow monolith may be washcoated with a slurry comprising catalytic support particles without applying a passivation layer to the wall flow monolith.

### BACKGROUND OF THE INVENTION

Embodiments of the present invention pertain to components for an emission treatment system for removing pollutants from an exhaust stream and methods for their manufacture. More particularly, the present invention relates to soot filters for exhaust systems and methods of manufacturing soot filters.

Diesel engine exhaust is a heterogeneous mixture which contains not only gaseous emissions such as carbon monoxide (“CO”), unburned hydrocarbons (“HC”) and nitrogen oxides (“NOₓ”), but also condensed phase materials (liquids and solids) which constitute the so-called particulates or particulate matter. Often, catalyst compositions and substrates on which the compositions are disposed are provided in diesel engine exhaust systems to convert certain or all of these exhaust components to innocuous components. For example, diesel exhaust systems can contain one or more of a diesel oxidation catalyst, a soot filter and a catalyst for the reduction of NOx.

Oxidation catalysts that contain platinum group metals, base metals and combinations thereof are known to facilitate the treatment of diesel engine exhaust by promoting the conversion of both HC and CO gaseous pollutants and some proportion of the particulate matter through oxidation of these pollutants to carbon dioxide and water. Such catalysts have generally been contained in units called diesel oxidation catalysts (DOC's), which are placed in the exhaust of diesel engines to treat the exhaust before it vents to the atmosphere. In addition to the conversions of gaseous HC, CO and particulate matter, oxidation catalysts that contain platinum group metals (which are typically dispersed on a refractory oxide support) also promote the oxidation of nitric oxide (NO) to NO₂. The total particulate matter emissions of diesel exhaust are comprised of three main components. One component is the solid, dry, solid carbonaceous fraction or soot fraction. This dry carbonaceous matter contributes to the visible soot emissions commonly associated with diesel exhaust. A second component of the particulate matter is the soluble organic fraction (“SOF”). The soluble organic fraction is sometimes referred to as the volatile organic fraction (“VOF”), which terminology will be used herein. The VOF can exist in diesel exhaust either as a vapor or as an aerosol (fine droplets of liquid condensate) depending on the temperature of the diesel exhaust. It is generally present as condensed liquids at the standard particulate collection temperature of 52° C. in diluted exhaust, as prescribed by a standard measurement test, such as the U.S. Heavy Duty Transient Federal Test Procedure. These liquids arise from two sources: (1) lubricating oil swept from the cylinder walls of the engine each time the pistons go up and down; and (2) unburned or partially burned diesel fuel.

The third component of the particulate matter is the so-called sulfate fraction. The sulfate fraction is formed from small quantities of sulfur components present in the diesel fuel. Small proportions of SO₃ are formed during combustion of the diesel, which in turn combines rapidly with water in the exhaust to form sulfuric acid. The sulfuric acid collects as a condensed phase with the particulates as an aerosol, or is adsorbed onto the other particulate components, and thereby adds to the mass of TPM.

One key aftertreatment technology in use for high particulate matter reduction is the diesel particulate filter. There are many known filter structures that are effective in removing particulate matter from diesel exhaust, such as honeycomb wall flow filters, wound or packed fiber filters, open cell foams, sintered metal filters, etc. However, ceramic wall flow filters, described below, receive the most attention. These filters are capable of removing over 90% of the particulate material from diesel exhaust. The filter is a physical structure for removing particles from exhaust, and the accumulating particles will increase the back pressure from the filter on the engine. Thus, the accumulating particles have to be continuously or periodically burned out of the filter to maintain an acceptable back pressure. Unfortunately, the carbon soot particles require temperatures in excess of 500° C. to burn under oxygen rich (lean) exhaust conditions. This temperature is higher than what is typically present in diesel exhaust.

Provisions are generally introduced to lower the soot burning temperature in order to provide for passive regeneration of the filter. The presence of a catalyst promotes soot combustion, thereby regenerating the filters at temperatures accessible within the diesel engine's exhaust under realistic duty cycles. In this way, a catalyzed soot filter (CSF) or catalyzed diesel particulate filter (CDPF) is effective in providing for >80% particulate matter reduction along with passive burning of the accumulating soot, and thereby promoting filter regeneration. In addition, the soot filter may further be catalyzed with an oxidation catalyst to promote the conversion of HC, CO and other pollutants as described above. These catalysts for conversion of HC and CO may be in addition to a separate oxidation catalyst in the system. The soot filter may further be catalyzed with a NOx abatement catalyst such as selective catalytic reduction (SCR) catalyst. In an SCR process, NOx is reduced with ammonia (NH₃) to nitrogen (N₂) over a catalyst typically composed of base metals. The technology is capable of NOx reduction greater than 90%, and thus it represents one of the best approaches for achieving aggressive NOx reduction goals. SCR is under development for mobile applications, with urea (typically present in an aqueous solution) as the source of ammonia. SCR provides efficient conversions of NOx as long as the exhaust temperature is within the active temperature range of the catalyst. The SCR catalyst may be disposed on a separate substrate or on the soot filter. With this approach, the catalyzed soot filter assumes two catalyst functions: removal of the particulate component of the exhaust stream and conversion of the NOx component of the exhaust stream to N₂.

Soot filters, and in particular, ceramic wall flow filters, are typically made of ceramic substrate materials such as aluminum titanate, cordierite, and silicon carbide that contains microcracks. When the soot filter is catalyzed with a coating of catalytic material in the form of a washcoat slurry containing particulate materials, the catalyst coating materials can enter these microcracks. The microcracks are believed to be open at low temperature and closed at high temperatures. This allows the filter to expand during soot regeneration without compromising the physical integrity of the filter. The existence of the microcracks in the filter keep the coefficient of thermal expansion low at higher temperatures. However, the presence of these catalytic coating materials in the microcracks makes the substrate less flexible, creating stress on the filter which can result in mechanical failure. Conventional coating processes utilize acetic acid or nitric acid before or during milling of catalytic coating materials so that the washcoat slurry is suitable for coating onto a filter substrate. Materials which possess these microcracks are passivated with a polymeric coating prior to applying the catalyst coating. Examples of such polymeric coatings are described in U.S. Pat. Nos. 4,532,228 and 7,166,555. The polymeric coating fills the cracks, generally with a polymeric material, followed by solidification. While the passivation process alleviates certain issues associated with washcoat material entering microcracks, this passivation step increases production costs and is an additional manufacturing step.

### SUMMARY OF THE INVENTION

Embodiments of the invention are directed toward methods of making a wall flow substrate coated with a catalyst washcoat. The wall flow substrate according to one or more embodiments has gas permeable walls formed into a plurality of axially extending channels, where each channel has one end plugged with any pair of adjacent channels plugged at the opposite ends thereof. The method according to one or more embodiments comprises applying at least one precious metal to a refractory metal oxide, preparing a slurry comprising the refractory metal oxide support, precious metal and an organic acid having at least two acid groups, milling the slurry to reduce the particle size of the impregnated refractory metal oxide support, providing a wall flow substrate and washcoating the wall flow substrate with the milled slurry.

Other embodiments of the invention are directed to catalyzed soot filters. The catalyzed soot filters comprise a wall flow substrate made from an aluminum titanate, cordierite, silicon carbide or combination material. The wall flow substrate has a washcoat of catalytic material adapted to convert hydrocarbons, CO and NOx applied directly to the wall flow substrate without a passivation layer between the substrate and the washcoat. The wall flow substrate has gas permeable walls formed into a plurality of axially extending channels, each channel having one end plugged with any pair of adjacent channels plugged at opposite ends thereof. Upon calcination of the wall flow substrate containing the washcoat, the catalyzed soot filter exhibits hydrocarbon, CO and NOx conversion that is greater at temperatures in the range of about 110° C. to about 140° C. than the hydrocarbon, CO and NOx conversion of an identical catalyzed soot filter but made with a passivation layer between the substrate and the washcoat.

### BRIEF DESCRIPTION OF THE DRAWINGS

FIG. 1 shows a schematic depiction of an embodiment of the emission treatment system of the invention;

FIG. 2 shows a perspective view of a wall flow filter substrate;

FIG. 3 shows a cutaway view of a section of a wall flow filter substrate;

FIG. 4 shows a comparison of the CO conversions between Samples A and B;

FIG. 5 shows a comparison of the total hydrocarbon conversion between Samples A and B;

FIG. 6 shows a comparison of the CO conversion among Samples C through F;

FIG. 7 shows a comparison of the total hydrocarbon conversion among Samples C through F;

FIG. 8 shows a comparison of the CO conversions among Samples G through M;

FIG. 9 shows a comparison of the total hydrocarbon conversion among Samples G through M;

FIG. 10 shows a comparison of the coefficient of thermal expansion for Samples N through S;

FIG. 11 shows a comparison of the elastic modulus values for Samples N through S;

FIG. 12 shows a comparison of the coefficient of thermal expansion values for Samples T through Y; and

FIG. 13 shows a comparison of the elastic modulus values for Samples T through Y.

### DETAILED DESCRIPTION OF THE INVENTION

Before describing several exemplary embodiments of the invention, it is to be understood that the invention is not limited to the details of construction or process steps set forth in the following description. The invention is capable of other embodiments and of being practiced or being carried out in various ways.

As used in this specification and the appended claims, the singular forms “a”, “an” and “the” include plural referents unless the context clearly indicates otherwise. Thus, for example, reference to “an acid” includes a mixture of two or more acids, and the like.

Embodiments of the invention relate to a coating process for making catalyzed soot filters for use as part of an emission treatment system. The purpose of an emission treatment system is to provide simultaneous treatment of the particulate matter, NOx and other gaseous components of diesel engine exhaust. The emission treatment system uses an integrated soot filter and catalytic function, for example, the oxidation of HC and CO. Moreover, due to the choice of catalytic compositions implemented in the system, effective pollutant abatement is provided for exhaust streams of varying temperatures. This feature is advantageous for operating diesel vehicles under varying loads and vehicle speeds which significantly impact exhaust temperatures emitted from the engines of such vehicles.

In one or more embodiments, the soot filters are produced without the use of a passivation layer, which results in catalyzed soot filters exhibiting at least one property improvement as described further below. Thus, according to one or more embodiments, a method for applying a catalyst composition to a soot filter is provided that does not require a polymer passivation step during manufacture such that the resulting soot filter exhibits physical properties superior to the blank filter. In one or more embodiments, the method involves the use of an acidic compound containing two or more carboxylic acid groups.

One embodiment of an emission treatment system is schematically depicted in FIG. 1. As can be seen in FIG. 1, the exhaust containing gaseous pollutants (including unburned hydrocarbons, carbon monoxide and NOx) and particulate matter is conveyed from the engine 15 to an oxidation catalyst 11. In the oxidation catalyst 11, unburned gaseous and non-volatile hydrocarbons (i.e., the VOF) and carbon monoxide are largely combusted to form carbon dioxide and water. Removal of substantial proportions of the VOF using the oxidation catalyst, in particular, helps prevent too great a deposition of particulate matter on the soot filter 12 (i.e., clogging), which is positioned downstream in the system. In addition, a substantial proportion of the NO of the NOx component is oxidized to NO₂ in the oxidation catalyst.

The exhaust stream is conveyed to the soot filter 12 which is coated with a catalyst composition. According to one or more embodiments, the particulate matter including the soot fraction and the VOF are also largely removed (greater than 80%) by the soot filter. The particulate matter deposited on the soot filter is combusted through the regeneration of the filter. The temperature at which the soot fraction of the particulate matter combusts is lowered by the presence of the catalyst composition disposed on the soot filter. The catalyzed soot filter 12 may optionally contain a catalyst for converting pollutants.

Wall flow substrates useful for supporting the catalyst compositions have a plurality of fine, substantially parallel gas flow passages extending along the longitudinal axis of the substrate. Typically, each passage is blocked at one end of the substrate body, with alternate passages blocked at opposite end-faces. Such monolithic carriers may contain greater than about 300 cell per square inch, and up to about 700 or more flow passages (or “cells”) per square inch of cross section, although far fewer may be used. For example, the carrier may have from about 7 to 600, more usually from about 100 to 400, cells per square inch (“cpsi”). The cells can have cross sections that are rectangular, square, circular, oval, triangular, hexagonal, or are of other polygonal shapes. Wall flow substrates typically have a wall thickness between 0.002 and 0.1 inches. Preferred wall flow substrates have a wall thickness of between 0.002 and 0.015 inches.

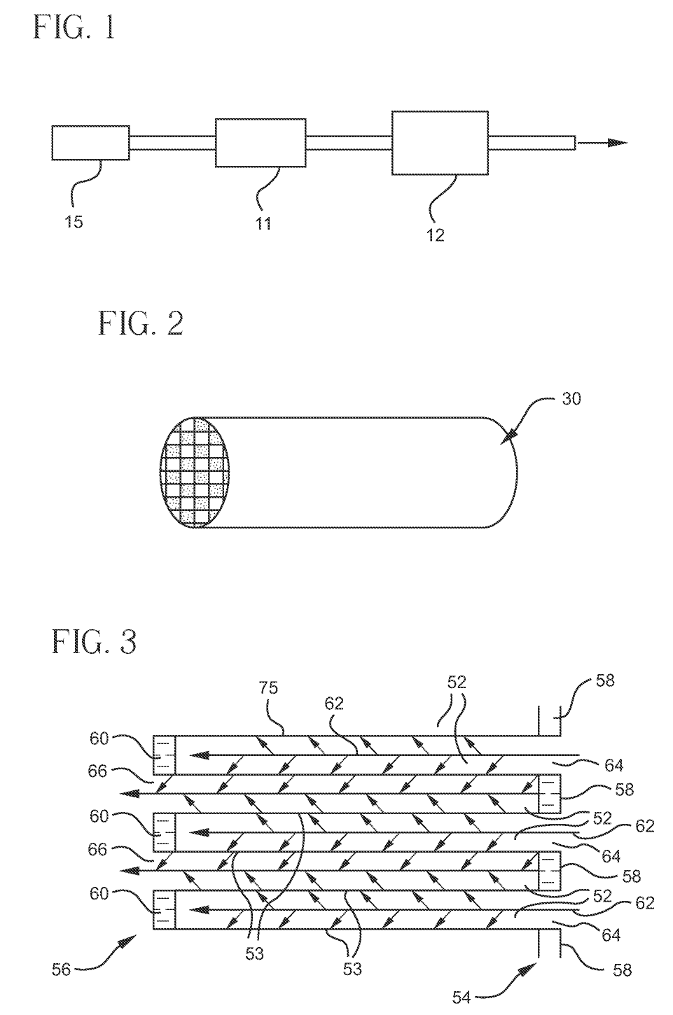

FIGS. 2 and 3 illustrate a wall flow filter substrate 30 which has a plurality of passages 52. The passages are tubularly enclosed by the internal walls 53 of the filter substrate. The substrate has an inlet end 54 and an outlet end 56. Alternate passages are plugged at the inlet end with inlet plugs 58, and at the outlet end with outlet plugs 60 to form opposing checkerboard patterns at the inlet 54 and outlet 56. A gas stream 62 enters through the unplugged channel inlet 64, is stopped by outlet plug 60 and diffuses through channel walls 53 (which are porous) to the outlet side 66. The gas cannot pass back to the inlet side of walls because of inlet plugs 58.

Wall flow filter substrates are composed of ceramic-like materials, including but not limited to, cordierite, α-alumina, silicon carbide, silicon nitride, zirconia, mullite, spodumene, alumina-silica-magnesia or zirconium silicate, or of porous, refractory metal. Wall flow substrates may also be formed of ceramic fiber composite materials. The wall flow monolith of other embodiments is one or more of aluminum titanate, cordierite, metal oxides and ceramics.

As noted above, an embodiment of the invention involves utilizing an organic acid such as a carboxylic acid during or prior to milling of the washcoat slurry. Suitable carboxylic acids include, but are not limited to, n-acetylglutamic acid ((2S)-2-acetamidopentanedioic acid), adipic acid (hexanedioic acid), aldaric acid, alpha-ketoglutaric acid (2-oxopentanedioic acid), aspartic acid ((2S)-2-aminobutanedioic acid), azelaic acid (nonanedioic acid), camphoric acid ((1R,3S)-1,2,2-trimethylcyclopentane-1,3-dicarboxylic acid), carboxyglutamic acid (3-aminopropane-1,1,3-tricarboxylic acid), citric acid (2-hydroxypropane-1,2,3-tricarboxylic acid), creatine-alpha ketoglutarate, dicrotalic acid (3-hydroxy-3-methylpentanedioic acid), dimercaptosuccinic acid (2,3-bis-sulfanylbutanedioic acid), fumaric acid (trans-butenedioic acid), glutaconic acid (pent-2-enedioic acid), glutamic acid ((2S)-2-aminopentanedioic acid), glutaric acid (pentanedioic acid), isophthalic acid (benzene-1,3-dicarboxylic acid m-phthalic acid), itaconic acid (2-methylidenebutanedioic acid), maleic acid (cis-butenedioic acid), malic acid (hydroxybutanedioic acid), malonic acid (propanedioic acid), mesaconic acid ((2E)-2-methyl-2-butenedioic acid), mesoxalic acid (2-oxopropanedioic acid), 3-methylglutaconic acid ((2E)-3-methylpent-2-enedioic acid), oxalic acid (ethanedioic acid), oxaloacetic acid (3-carboxy-3-oxopropanoic acid), phthalic acid (benzene-1,2-dicarboxylic acid o-phthalic acid), phthalic acids (mixture of the ortho, meta and para benzene dicarboxylic phthalic acids), pimelic acid (heptanedioic acid), sebacic acid (decanedioic acid), suberic acid (octanedioic acid), succinic acid (butanedioic acid), tartaric acid (2,3-dihydroxybutanedioic acid), tartronic acid (2-hydroxypropanedioic acid), terephthalic acid (benzene-1,4-dicarboxylic acid p-phthalic acid), traumatic acid (dodec-2-enedioic acid), trimesic acid (benzene-1,3,5-tricarboxylic acid), derivatives thereof and combinations thereof.

Accordingly, one or more embodiments of the invention are directed toward methods of making wall flow substrates coated with a catalyst washcoat. The method comprises applying at least one precious metal to a refractory metal oxide; preparing a slurry comprising the refractory metal oxide support, precious metal and an organic acid having at least two acid groups; milling the slurry to reduce the particle size of the impregnated refractory metal oxide support; and washcoating a wall flow substrate with the milled slurry. The wall flow substrate has gas permeable walls formed into a plurality of axially extending channels. Each channel has one end plugged with adjacent channels plugged at the opposite ends.

Some embodiments include the addition of an organic acid during the milling process. Other embodiments have the washcoating performed directly on the substrate in the absence of a passivation layer.

The at least one precious metal according to one or more embodiments of the invention includes one or more of platinum, palladium, ruthenium, iridium and rhodium. In detailed embodiments the precious metal is platinum, palladium or a combination of platinum and palladium.

The organic acid of one or more embodiments comprises more than one carboxylic acid group. Further embodiments of the invention have the organic acid being one or more of tartaric acid, citric acid, n-acetylglutamic acid, adipic acid, alpha-ketoglutaric acid, aspartic acid, azelaic acid, camphoric acid, carboxyglutamic acid, citric acid, dicrotalic acid, dimercaptosuccinic acid, fumaric acid, glutaconic acid, glutamic acid, glutaric acid, isophthalic acid, itaconic acid, maleic acid, malic acid, malonic acid, mesaconic acid, mesoxalic acid, 3-methylglutaconic acid, oxalic acid, oxaloacetic acid, phthalic acid, phthalic acids, pimelic acid, sebacic acid, suberic acid, succinic acid, tartronic acid, terephthalic acid, traumatic acid, trimesic acid, carboxyglutamate, derivatives thereof and combinations thereof. In a detailed embodiment, the organic acid is tartaric acid.

In further embodiments of the invention, the refractory metal oxide support is selected from the group consisting of silica on alumina, zeolite and combinations thereof. In still further embodiments, the wall flow substrate is made of a material selected from the group consisting of silicon carbide, aluminum titanate, cordierite and combinations thereof.

According to one or more embodiments of the invention, during the milling step the particle size of at least about 90% of the impregnated refractory metal oxide support is reduced to less than about 10 μm. In more detailed embodiments, the particle size of at least about 90% of the impregnated metal oxide support particles is less than about 5 μm. In even more detailed embodiments, the particle size is milled to less than about 4 μm.

Further embodiments are directed toward methods of making a catalyst coated wall flow substrate without a passivation layer. The method comprises the steps of impregnating a refractory metal oxide support with at least one precious metal; creating a slurry comprising the impregnated refractory metal oxide support and an organic acid having at least two acid groups; milling the slurry to reduce the particle size of the impregnated refractory metal oxide support; and washcoating the wall flow substrate with the milled slurry without first applying a passivation layer to the wall flow substrate. The wall flow substrate has gas permeable walls formed into a plurality of axially extending channels, each channel having one end plugged with any pair of adjacent channels plugged at opposite ends thereof.

Still further embodiments are to catalyzed soot filters comprising a wall flow substrate. The wall flow substrate may be made from an aluminum titanate, cordierite, silicon carbide or combination material. The wall flow substrate may also have a washcoat of catalytic material adapted to convert hydrocarbons, CO and NOx applied directly to the wall flow substrate without a passivation layer between the substrate and the washcoat. The wall flow substrate comprises gas permeable walls formed into a plurality of axially extending channels. Each channel has one end plugged with adjacent channels plugged at opposite ends. Upon calcination of the wall flow substrate containing the washcoat, the catalyzed soot filter exhibits hydrocarbon, CO and NOx conversion that is greater, at temperatures in the range of about 110° C. to about 140° C., than the hydrocarbon, CO and NOx conversion of an identical catalyzed soot filter made with a passivation layer between the substrate and the washcoat.

Embodiments of the invention are exemplified by the following Examples, which are not intended to limit the present invention.

### EXAMPLES

### Manufacture of Group I Samples (Samples A and B)

### Sample A

The substrate is a SiC wall-flow substrate with a porosity of 58%, mean pore size (MPS) of 23 μm, a cell density of 300/in² and a wall thickness of 12 mil. The filter substrate is a square segment having a dimension of 34 mm×34 mm×150 mm.

This catalyst has the following composition: 60 g/ft³ Pt, 30 g/ft³ Pd, 0.5 g/in³ 1.5% silica/alumina 1.5/100 (1.5% Si on Al₂O₃), 0.2 g/in³ Beta zeolite, and 0.035 g/in³ ZrO2. The total washcoat loading is 0.78 g/in³.

The catalyst coating slurry was prepared by the following process. Pt tetra monoethanolamine hydroxide solution was impregnated onto the 1.5% silica/alumina powder via the incipient wetness technique in a planetary mixer. Then, Pd nitrate was applied on the Pt/1.5% silica/alumina powder using the same impregnation technique. The precious metal impregnated powder was then dispersed into water to make slurry. This slurry was milled using a continuous mill to reduce the particle size to 90% less than 5 micrometers (D₉₀<5 μm). Before the completion of milling, Zr acetate and zeolite were added into the slurry. The resulting slurry was further diluted with water to achieve 20% solid by weight.

The slurry was then washcoated by immersing the substrate into the slurry with inlet side of the substrate down and the outlet side just above (about ¼ inch) the slurry level. The substrate was pulled out of the slurry, and a stream of air was blown from the outlet side until no washcoat slurry coming out. The coated sample was then dried at 110° C. for 2 hours and calcined in air at 450° C. for 1 hour.

### Sample B

This sample is the same as Sample A with the following exceptions. After impregnating Pt and Pd, the powder was calcined at 500° C. for 2 hours. Tartaric acid was added before the milling so that the pH of the milled slurry reached to pH 4.0.

### Preparation of Group II Samples (Samples C to F)

### Sample C

The filter substrate used for this sample is a SiC wall-flow substrate with a porosity of 52%, mean pore size (MPS) of 23 μm, a cell density of 300/in² and a wall thickness of 12 mil. The filter substrate is a square segment having a dimension of 34 mm×34 mm×150 mm.

This catalyst has the following composition: 60 g/ft³ Pt and 30 g/ft³ Pd throughout the filter length, 0.5 g/in³ 1.5% silica/alumina 1.5/100 (1.5% Si on Al₂O₃) as precious metal support and 0.2 g/in³ Beta zeolite in the front zone (50% length), 0.7 g/in³ 1.5% silica/alumina 1.5/100 (1.5% Si on Al₂O₃) as precious metal support in the rear zone (50% length). The total washcoat loading is 0.75 g/in³.

The catalyst coating slurry was prepared by the following process. Pt tetra monoethanolamine hydroxide solution was impregnated onto the 1.5% silica/alumina powder via the incipient wetness technique in a Planetary mixer. Then, Pd nitrate was applied on the Pt/1.5% silica/alumina powder using the same impregnation technique. The precious metal impregnated powder was then dispersed into water to make a slurry. This slurry was milled using a continuous mill to reduce the particle size to 90% less than 4 micrometer (D₉₀<4 μm). Before the completion of milling, zeolite was added into the slurry. The resulting slurry was further diluted with water to achieve 14% solid by weight.

The slurry was then washcoated by immersing the substrate into the slurry with inlet side of the substrate down and the outlet side just above (about ¼ inch) the slurry level. The substrate was pulled out of the slurry, and a stream of air was blown from the outlet side until no washcoat slurry coming out. The coated sample was then dried at 110° C. for 2 hours and calcined in air at 450° C. for 1 hour.

### Sample D

This sample is the same as Sample C with the following exceptions. After impregnating Pt and Pd on 1.5% silica/alumina, the powder was calcined at 500° C. for 2 hours. Tartaric acid was added before the milling so that the pH of the milled slurry reached to pH 4.0.

### Sample E

This sample is same as Sample D, except the precious metal level is 70 g/ft³ throughout the filter length.

### Sample F

This sample is same as Sample D, except the precious metal level is 50 g/ft³ throughout the filter length.

### Preparation of Group III Samples (Samples G to M)

### Sample G

The substrate is a SiC wall-flow substrate with a porosity of 52%, mean pore size (MPS) of 23 μm, a cell density of 300/in² and a wall thickness of 12 mil. The filter substrate is a square segment having a dimension of 34 mm×34 mm×150 mm.

This catalyst has the following composition: 46.7 g/ft³ Pt, 23.3 g/ft³ Pd, 0.5 g/in³ 1.5% silica/alumina 1.5/100 (1.5% Si on Al₂O₃) and 0.1 g/in³ beta zeolite. The composition is the same throughout the length of the filter.

The catalyst coating slurry was prepared by the following process. Pt tetra monoethanolamine hydroxide solution was impregnated onto the 1.5% silica/alumina powder via the incipient wetness technique in a Planetary mixer. Then, Pd nitrate was applied on the Pt/1.5% silica/alumina powder using the same impregnation technique. The precious metal impregnated powder was then dispersed into water to make a slurry. This slurry was milled using a continuous mill to reduce the particle size to 90% less than 4 micrometer (D₉₀<4 μm). Before the completion of milling, zeolite was added into the slurry. The resulting slurry was further diluted with water to achieve 19% solid by weight. The final pH of the slurry was 4.1.

The slurry was then washcoated by immersing the substrate into the slurry with inlet side of the substrate down and the outlet side just above (about ¼ inch) the slurry level. The substrate was pulled out of the slurry, and a stream of air was blown from the outlet side until no washcoat slurry coming out. The coated sample was then dried at 110° C. for 2 hours and calcined in air at 450° C. for 1 hour.

### Sample H

Sample H is same as Sample G, except the precious metal impregnation step. After Pt impregnation, tartaric acid (7% of 1.5% silica/alumina powder by weight) was added to the powder in solution form, which was then followed by the Pd impregnation like in Sample G. The final pH of the slurry was 3.5.

### Sample I

Sample I is same as Sample G, except the precious metal impregnation step. After both Pt and Pd impregnation steps, tartaric acid (7% of 1.5% silica/alumina powder by weight) was added to the powder in solution form. The final pH of the slurry was 3.6.

### Sample J

Sample J is the same as Sample G with the following exceptions. After impregnating Pt and Pd, the powder was calcined at 450° C. for 1 hour. Tartaric acid was added before the milling so that the pH of the milled slurry reached to pH 4.0.

### Sample K

Sample K is same as Sample J, except citric acid was used in place of tartaric acid. The final pH of the slurry was 3.6.

### Sample L

Sample L is same as Sample J, except nitric acid was used in place of tartaric acid. The final pH of the slurry was 4.1.

### Sample M

Sample M is same as Sample J, except acetic acid was used in place of tartaric acid. The final pH of the slurry was 4.0.

### Preparation of Group IV Samples (Samples N to S)

The filter substrate for Samples N to S is made of aluminum titanate with a porosity of 51% MPS of 14-15 μm, 300 cpsi and a wall thickness of 13 mil. The substrate has a dimension of 2″×6″ round. The catalyzed soot filters have an identical composition (with the exception of Sample S): 50 g/ft³ PGM (Pt/Pd=2:1 by weight), 1.5% silica/alumina 1.5/100 support, 0.1 g/in³ beta zeolite. The particle size distributions are also identical, D₉₀<5 μm [90% less than 5 μm].

### Sample N

Sample N was made by a standard process identical to the process used for Sample G.

### Sample O

Sample O was made using a process identical to Sample H.

### Sample P

Sample P was made using a process the same as Sample J, except two modifications. One, the calcinations of the powder was done at 400° C. for 1 hour; and second, the final pH of the slurry was controlled to pH 5.0.

### Sample Q

Sample Q was made using the same process as Sample O, except that citric acid was used in place of tartaric acid.

### Sample R

Sample R was made using the identical process as Sample P, except that citric acid was used in place of tartaric acid.

### Sample S

Sample S does not contain any precious metal. 1.5% silica/alumina 1.5/100 is the only component. The powder was milled with tartaric acid to obtain a pH of 5.5.

### Preparation of Group V Samples (Samples T to Y)

Samples T to Y were made on a Cordierite filter substrate, which has a porosity of 50% and MPS of 19, and cell a geometry of 300 cpsi/15 mil. The substrates are 2″ in diameter and 6″ long round sample cores. These samples have the following catalyst composition: 50 g/ft³ PGM (Pt/Pd=2:1 by weight), 0.5 g/in³ 1.5% silica/alumina, 0.1 g/in³ beta zeolite.

### Sample T

Sample T is a reference sample which was made using the identical process as Sample G.

### Sample U

Sample U was made using the same process as Sample H, except 5% tartaric acid was added after the Pt impregnation.

### Sample V

Sample V is the same as Sample U, except 7% tartaric acid was used.

### Sample W

Sample W is the same as Sample V, except 9% tartaric acid was used.

### Sample X

Sample X is the same as Sample G, except the precious metal impregnation step. After the sequential impregnation of Pt and Pd, the powder was calcined at 400° C. for 1 hour. Tartaric acid (equivalent to 7% of the support by weight) was added to the slurry before milling.

### Sample Y

Sample Y is the same as Sample X, except citric acid was used in place of tartaric acid.

### Catalyst Test Conditions

The catalyzed soot filter samples were tested in a flow reactor system with a feed containing 1000 ppm CO, 420 ppm hydrocarbons on a C1 basis, 10% O₂ and 10% water. The hydrocarbons include 120 ppm propene, 80 ppm toluene, 200 ppm decane and 20 ppm methane, all on C1 basis. The space velocity for the test was 35,000 h⁻¹. The system was equipped with CO, HC, CO₂ analyzers as well as a FTIR spectrometer and a mass spectrometer, which were used to determine the conversion efficiency of a catalyst. A catalyst was first saturated with the feed at 90° C. After 90 seconds of stabilization at 90° C., the temperature was ramped to 300° C. at 20° C./minute. The concentrations of reactants and products were continuously monitored and recorded. The conversions of CO and total hydrocarbons (THC) at various times were calculated as a relative difference between the concentration in feed (without passing the catalyst) and the resulting concentration after passing through the catalyst. Before testing, the samples were aged in an apparatus at 700° C. for 4 hours with flowing air and 10% steam.

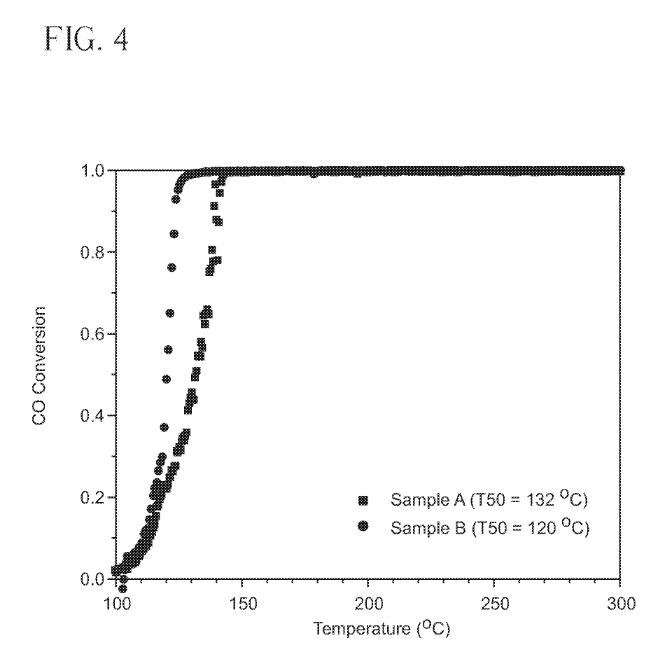

FIG. 4 shows that Samples A and B, which have an identical catalyst composition but made with different slurry processes, have different activities in CO conversion. Sample B made through the tartaric acid process light-off CO at lower temperatures (T₅₀=120° C.) than Sample A (T₅₀=132° C.) made by the standard process. [T₅₀ is the temperature at 50% conversion.]

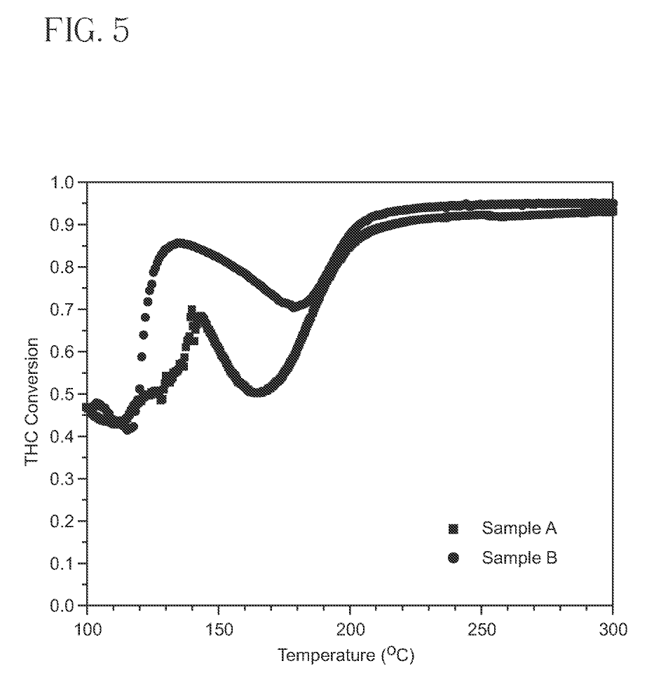

FIG. 5 shows that Sample B has a much higher HC conversion than Sample A at lower temperatures (T<180° C.). THC conversion at lower temperatures can be attributed to the HC storage function of zeolite material. This result indicates that the tartaric acid process can maintain the HC storage function better than Sample A.

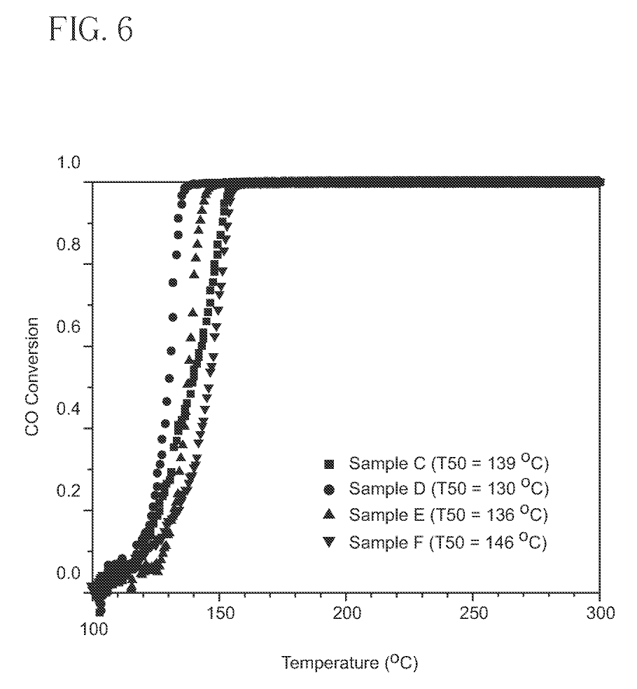

FIG. 6 compares the CO conversions for 90 g/ft³ sample made by standard process (Sample C) and the tartaric acid processed samples with 90 (Sample D), 70 (sample E) and 50 (sample F) g/ft³ precious metal. The samples made by tartaric acid process (Samples D and E) have lower T₅₀ than the standard sample (Sample C) even though Sample E has a lower metal loading than Sample C.

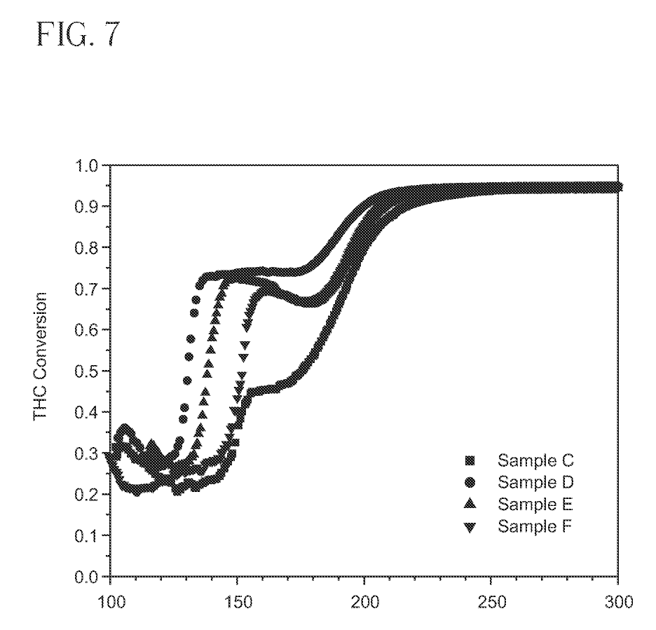

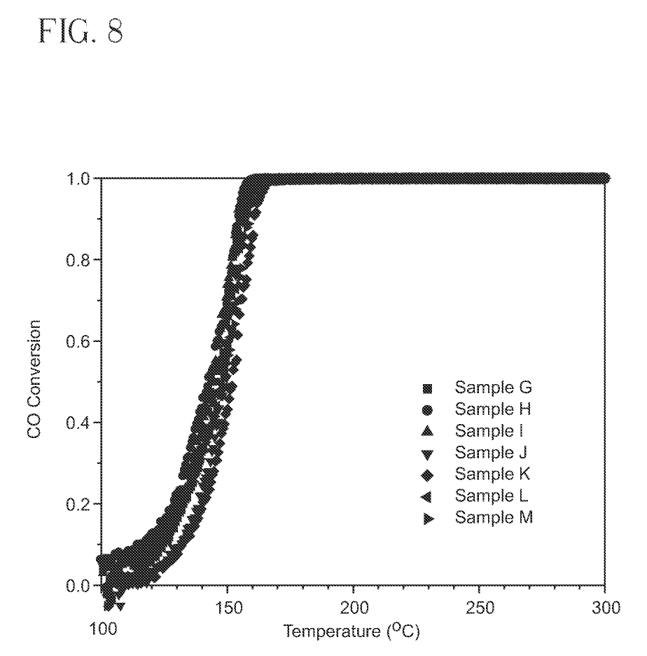

FIG. 7 illustrates the comparison of THC conversions among Samples C to F. All the samples made by tartaric acid process Samples D to F), regardless of metal loading, are superior to the 90 g/ft³ standard sample Sample C) in THC conversion.

FIG. 8 shows the comparison of CO conversions for Samples G to M. The CO light-off for all the samples for this series are similar; the spread of T₅₀ is within 9° C.

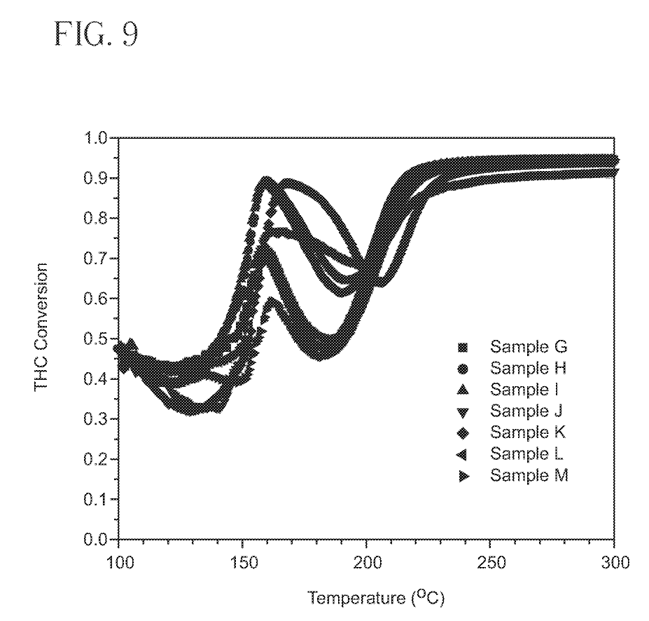

FIG. 9 shows the comparison of THC conversions for Samples G to M. Clearly, Samples made by tartaric acid process (Samples H, I, J) or citric acid process (Sample K) have higher THC conversions compared to samples made by the standard process (sample G) or acetic acid process (Sample M) or nitric acid process (Sample L).

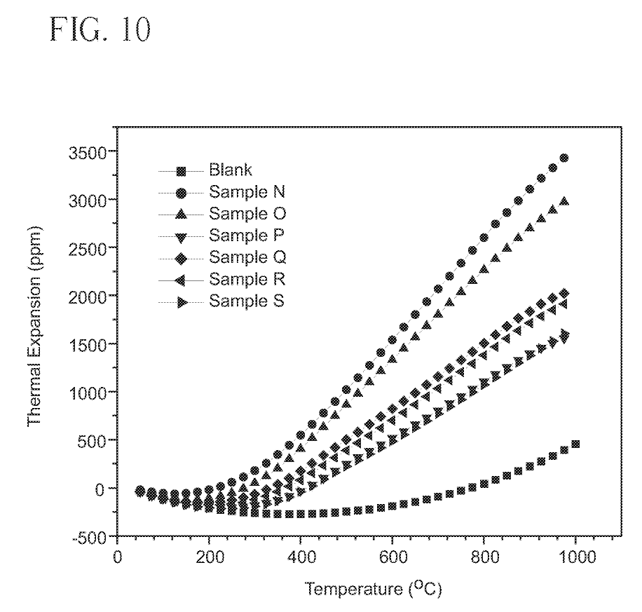

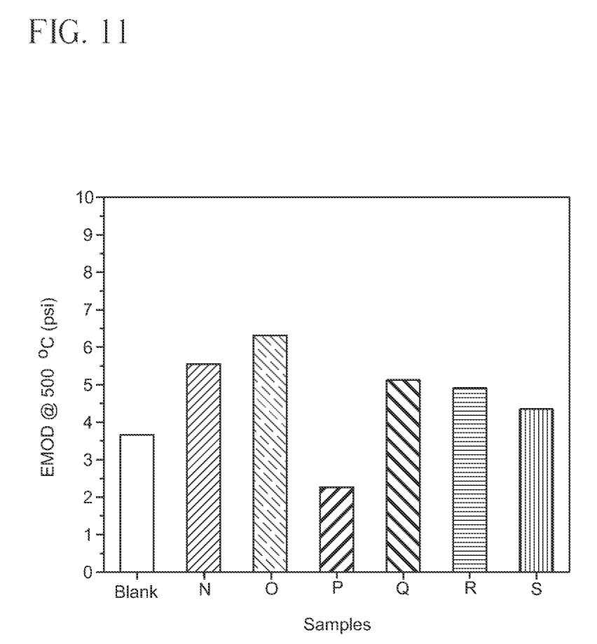

FIG. 10 shows that coated alumimum titanate samples made using the tartaric acid process or the citric acid process (with powder calcination) have lower coefficient of thermal expansion (CTE) values compared to the standard sample (Sample N).

FIG. 11 shows that all coated alumimum titanate samples, especially, Sample P, have comparable elastic modulus (EMOD).

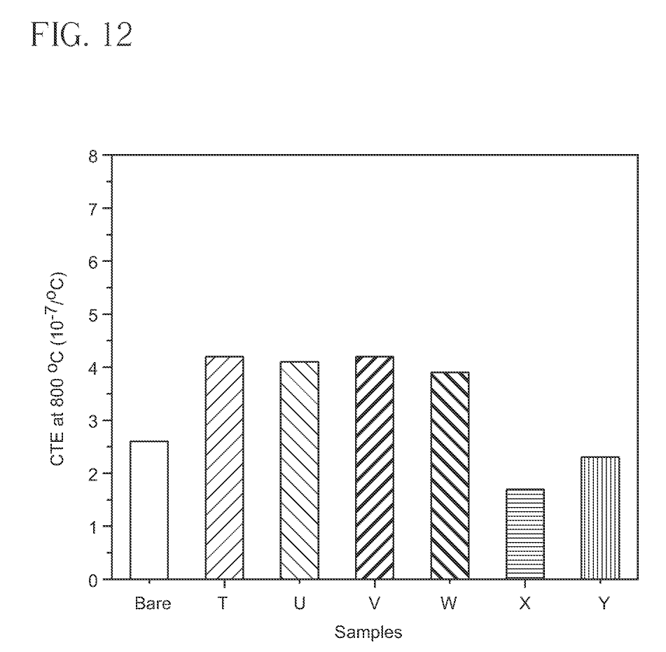

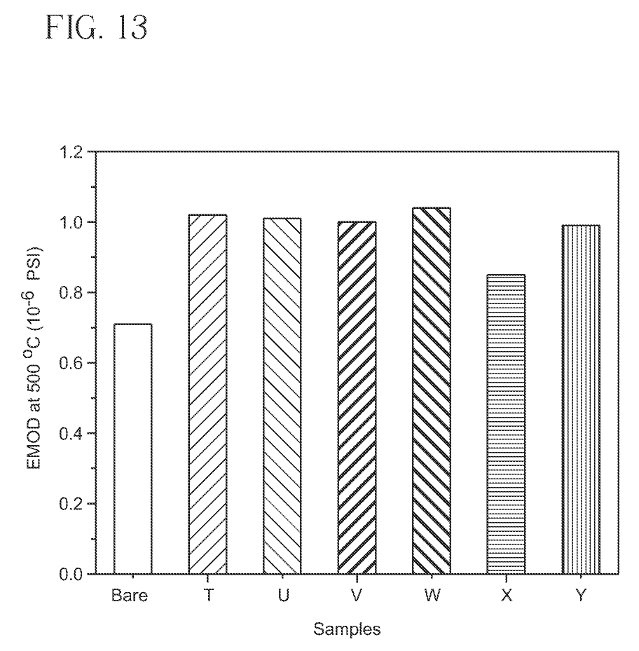

FIG. 12 shows that Samples X and Y have comparable CTE to the bare substrate.

FIG. 13 shows that all coated cordierite samples, especially have comparable EMOD.

Accordingly, while the present invention has been disclosed in connection with various embodiments thereof, it should be understood that other embodiments might fall within the spirit and scope of the invention, as defined by the following claims.

Reference throughout this specification to “one embodiment,” “certain embodiments,” “one or more embodiments” or “an embodiment” means that a particular feature, structure, material, or characteristic described in connection with the embodiment is included in at least one embodiment of the invention. Thus, the appearances of the phrases such as “in one or more embodiments,” “in certain embodiments,” “in one embodiment” or “in an embodiment” in various places throughout this specification are not necessarily referring to the same embodiment of the invention. Furthermore, the particular features, structures, materials, or characteristics may be combined in any suitable manner in one or more embodiments.

Although the invention herein has been described with reference to particular embodiments, it is to be understood that these embodiments are merely illustrative of the principles and applications of the present invention. It will be apparent to those skilled in the art that various modifications and variations can be made to the method and apparatus of the present invention without departing from the spirit and scope of the invention. Thus, it is intended that the present invention include modifications and variations that are within the scope of the appended claims and their equivalents.

We claim:

1. A method of making a wall flow substrate coated with a catalyst washcoat, comprising:
applying at least one precious metal to a refractory metal oxide;
preparing a slurry comprising the refractory metal oxide support, precious metal and an organic acid having at least two acid groups;
milling the slurry to reduce the particle size of the impregnated refractory metal oxide support; and
providing a wall flow substrate having gas permeable walls formed into a plurality of axially extending channels, each channel having one end plugged with any pair of adjacent channels plugged at opposite ends thereof, and washcoating the wall flow substrate with the milled slurry.

2. The method of claim 1, wherein the organic acid is added before milling.

3. The method of claim 1, wherein the organic acid is added during milling.

4. The method of claim 1, wherein the washcoating is performed directly on the substrate in the absence of a passivation layer.

5. The method of claim 1, wherein the at least one precious metal is selected from the group consisting of platinum, palladium, ruthenium, iridium, rhodium and combinations thereof.

6. The method of claim 1, wherein the organic acid comprises more than one carboxylic acid group.

7. The method of claim 6, wherein the organic acid having more than one carboxylic acid group is selected from the group consisting of tartaric acid, citric acid, n-acetylglutamic acid, adipic acid, alpha-ketoglutaric acid, aspartic acid, azelaic acid, camphoric acid, carboxyglutamic acid, citric acid, dicrotalic acid, dimercaptosuccinic acid, fumaric acid, glutaconic acid, glutamic acid, glutaric acid, isophthalic acid, itaconic acid, maleic acid, malic acid, malonic acid, mesaconic acid, mesoxalic acid, 3-methylglutaconic acid, oxalic acid, oxaloacetic acid, phthalic acid, phthalic acids, pimelic acid, sebacic acid, suberic acid, succinic acid, tartronic acid, terephthalic acid, traumatic acid, trimesic acid, carboxyglutamate, derivatives thereof and combinations thereof.

8. The method of claim 1, wherein the organic acid is tartaric acid.

9. The method of claim 1, wherein the at least one precious metal is a combination of platinum and palladium.

10. The method of claim 1, wherein the refractory metal oxide support is selected from the group consisting of silicon on alumina, zeolite and combinations thereof.

11. The method of claim 1, wherein the wall flow substrate is made of a material selected from the group consisting of silicon carbide, aluminum titanate, cordierite and combinations thereof.

12. The method of claim 1, wherein the milling reduces particle size of at least about 90% of the impregnated refractory metal oxide support to less than about 5 μm.

13. The method of claim 1, wherein the milling reduces particle size of at least about 90% of the impregnated refractory metal oxide support to less than about 4 μm.

14. A method of making a catalyst coated wall flow substrate without a passivation layer, comprising:
impregnating a refractory metal oxide support with at least one precious metal;
creating a slurry comprising the impregnated refractory metal oxide support and an organic acid having at least two acid groups;
milling the slurry to reduce the particle size of the impregnated refractory metal oxide support; and
providing a wall flow substrate having gas permeable walls formed into a plurality of axially extending channels, each channel having one end plugged with any pair of adjacent channels plugged at opposite ends thereof, and washcoating the wall flow substrate with the milled slurry without first applying a passivation layer to the wall flow substrate.

15. A catalyzed soot filter comprising a wall flow substrate made from an aluminum titanate, cordierite, silicon carbide or combination material having a washcoat of catalytic material adapted to convert hydrocarbons, CO and NOx applied directly to the wall flow substrate without a passivation layer between the substrate and the washcoat, the wall flow substrate having gas permeable walls formed into a plurality of axially extending channels, each channel having one end plugged with any pair of adjacent channels plugged at opposite ends thereof, wherein upon calcination of the wall flow substrate containing the washcoat, the catalyzed soot filter exhibits hydrocarbon, CO and NOx conversion that is greater at temperatures in the range of about 110° C. to about 140° C. than the hydrocarbon, CO and NOx conversion of an identical catalyzed soot filter but made with a passivation layer between the substrate and the washcoat.
